(19) United States
(12) Patent Application Publication
(10) Pub. No.: US 2011/0167999 A1
(43) Pub. Date: Jul. 14, 2011

(54) NONWOVEN CONSTRUCTION PRODUCT AND METHOD OF MAKING THE SAME

(76) Inventors: Allan Marcus Dellinger, Weddington, NC (US); Joseph C. Moon, Greer, SC (US); Steven F. Nielsen, Charlotte, NC (US)

(21) Appl. No.: 12/028,230

(22) Filed: Feb. 8, 2008

Related U.S. Application Data
(60) Provisional application No. 60/888,811, filed on Feb. 8, 2007.
(60) Provisional application No. 60/888,814, filed on Feb. 8, 2007.

(51) Int. Cl. F41H 5/02; F41H 5/04; B32B 5/26; A47C 19/00; D04H 13/00; D04H 1/08; B32B 5/06

(52) U.S. Cl. 89/36.02; 442/324; 428/156; 428/172; 442/1; 442/270; 442/86; 29/592; 89/903; 89/904; 89/916; 89/915

(57) ABSTRACT

A protective armor product comprised of a panel which defines the interior and perimeter profile of the protective armor product. The panel is comprised of a stiff fibrous boardstock material with one or more layers of fibrous felted material of densified needlepunched construction. The fibrous felted material is comprised of a plurality of entangled polymeric fibers where at least a portion of the entangled polymeric fibers are melt fused together such that a plurality of fiber to fiber fusion bonding points are distributed within the fibrous felted material. The stiff fibrous boardstock material is formed into the panels to make the protective armor product.

### RELATED APPLICATION

This application claims the benefit of co-pending provisional application Ser. No. 60/888,811 filed Feb. 8, 2007 and co-pending provisional application Ser. No. 60/888,814 filed Feb. 8, 2007.

### FIELD OF THE INVENTION

The invention relates to a protective armor product and/or a construction product that is made from a stiff fibrous boardstock material comprising one or more layers of a fibrous felted material of densified needlepunched construction and a method for making the products. The products are water resistant and impact resistant. The protective armor product may be used to protect an individual, a vehicle or a structure. The construction product may be used to construct any product traditionally constructed from plywood, marine grade plywood, marine grade plastic, and the like.

### BACKGROUND OF THE INVENTION

The use of felted fibrous material such as needlepunched felt is known in the prior art. Particular reference is made to U.S. Pat. No. 7,111,342, herein incorporated by reference. Therein, a stiff fibrous boardstock material is described.

The search for lighter, stronger armor with superior mobility has continued throughout the centuries. Today, most personal body armor is made of ballistic cloth (e.g. Kevlar, Dyneema, Twaron, Spectra) and ceramic and metal plates. Vehicle armor and structure armor are made of a variety of materials including, but not limited to, steel, ceramic, plastic, ballistic cloth, coal-based carbon foam, and depleted uranium. Examples include composite armor, which consists of differing layers of material sandwiched together, such as a ceramic layer sandwiched between two steel plates, the use of honeycomb structures sandwiched between steel plates, spaced armor, which consists of two or more spaced a distant apart from one another, and reactive armor, which consists of a high explosive sandwiched between armor plates. However, each of the above mentioned materials is heavy, cumbersome, and lacking in energy dissipation. Hence, there exists an unsatisfied need for a lightweight, strong armor that is impact resistant and dissipates impact energy.

Additionally, a need exists for a lightweight material which is resistant to moisture damage in environments ranging from low moisture content to high moisture content. Currently marine grade plywood is commonly used in such environments. Marine plywood is specially treated plywood that is designed to resist rotting in a high-moisture environment and it is frequently used in the construction of docks and boats. The qualities of marine plywood may be enhanced by being overlaid with fiberglass. However, marine plywood is a heavy material and it will eventually succumb to damage due to water infiltration resulting in rotting, fungal decay, and delamination. Additionally, marine plywood is an expensive product, translating into a cost that is between three and four times the cost of standard plywood. Hence, a need exists for a lightweight, strong nonwoven product which is resistant to moisture damage.

### SUMMARY OF THE INVENTION

A protective armor product comprised of a panel which defines the interior and perimeter profile of the protective armor product. The panel is comprised of a stiff fibrous boardstock material with one or more layers of fibrous felted material of densified needlepunched construction. The fibrous felted material is comprised of a plurality of entangled polymeric fibers where at least a portion of the entangled polymeric fibers are melt fused together such that a plurality of fiber to fiber fusion bonding points are distributed within the fibrous felted material. The stiff fibrous boardstock material is formed into the panels to make the protective armor product and/or the construction product.

### BRIEF DESCRIPTION OF THE DRAWINGS

For the purpose of illustrating the invention, there is shown in the figures a form that is presently preferred; it being understood, however, that this invention is not limited to the precise arrangements and instrumentalities shown.

FIG. 1 illustrates an embodiment of the formation of a fibrous nonwoven precursor for manufacturing a stiff fibrous boardstock material.

FIG. 2 illustrates an embodiment of a combining and integration station.

FIG. 3 illustrates an embodiment of a lamination station.

FIG. 4 illustrates an embodiment of the formation of a stiff fibrous boardstock material from a multilayer sandwich material.

FIG. 5 illustrates an embodiment of a fibrous felted material.

FIG. 6 illustrates an embodiment of a multilayer sandwich material.

### DETAILED DESCRIPTION

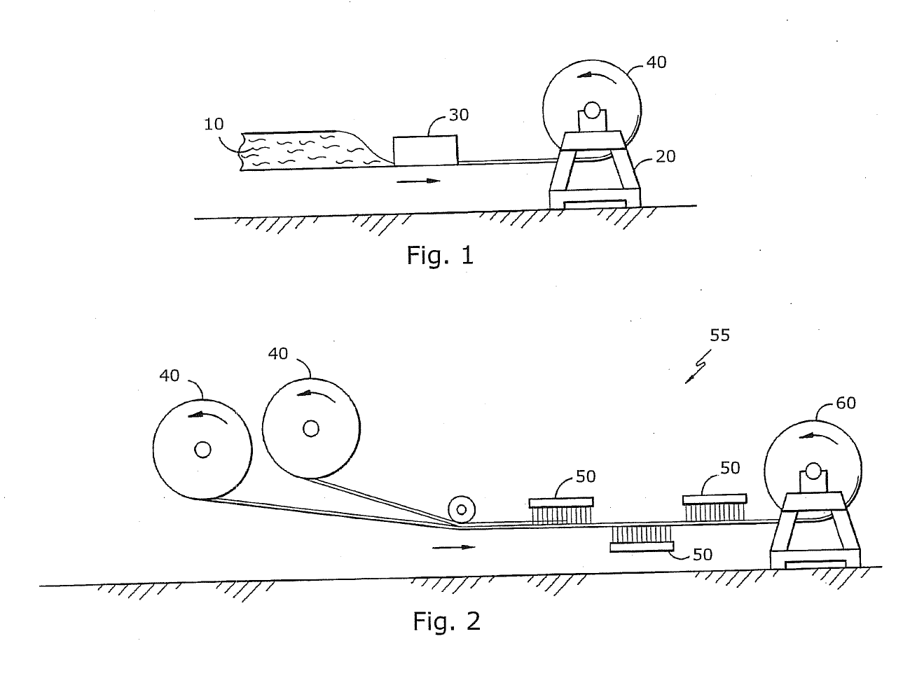

Referring to the drawings, wherein like numerals indicate like elements, there is shown in FIG. 1 an embodiment of the start of a process for manufacturing a stiff fibrous boardstock material 90. The process beings with a plurality of entangled polymeric fibers 10 being subjected to carding 30 resulting in a sliver 40 which is then collected, on a roll in FIG. 1, atop a stand 20. In another embodiment of the present invention, a plurality of entangled polymeric fibers 10 which are staple based may be subjected to nonwoven processes which include, but are not limited to, wet laying, air laying, carding, or combinations thereof. In yet another embodiment, a plurality of entangled polymeric fibers 10 which are continuous filament may be subjected to nonwoven processes which include, but are not limited to, melt blowing, spunbonding, threaded roll, or combinations thereof. In still another embodiment, a plurality of entangled polymeric fibers 10 may be subjected to other processes which include, but are not limited to, weaving, knitting, filming, foaming, OSB, or combinations thereof.

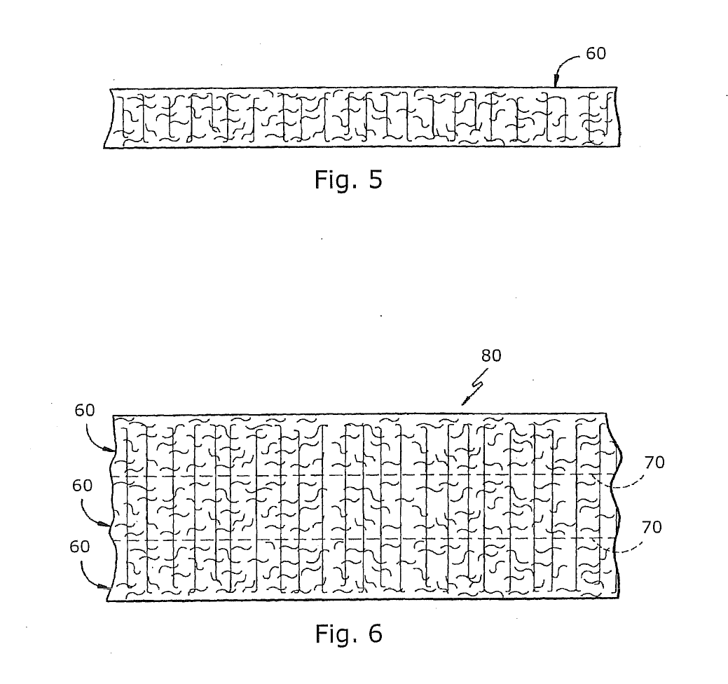

Referring now to FIG. 2, an embodiment of a combining and integrating station 55 is illustrated. Two or more rolls of sliver 40 are combined and integrated into a fibrous felted material 60 through the use of one or more needle looms 50. In another embodiment of the present invention, two or more rolls of sliver 40 are combined and integrated using hydroentanglement. In yet another embodiment, two or more rolls of sliver 40 are combined and integrated using spunbonding. The fibrous felted material 60 is then collected by some means, such as a roll. FIG. 5 illustrates one potential embodiment of a fibrous felted material 60.

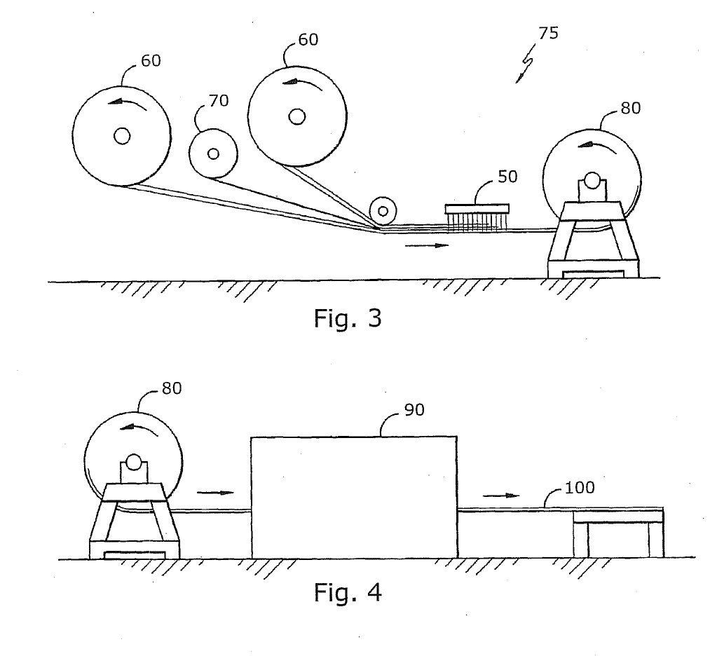

Referring now to FIG. 3, an embodiment of a lamination station 75 is illustrated. Two or more rolls of fibrous felted material 60 are combined with a layer of adhesive material 70 integrated between each layer of fibrous felted material 60. The two or more rolls of fibrous felted material 60 and layers of adhesive material 70 are then combined and integrated into a multilayer sandwich material 80 through the use of one or more needle looms 50. The multilayer sandwich material 80 is then collected by some means, such as a roll. FIG. 6 illustrates one potential embodiment of a fibrous felted material 60. In another embodiment of the present invention, bicomponent fibers and/or filaments replace the use of adhesive material 70. In still another embodiment, bicomponent fibers and/or filaments supplement the used of adhesive material 70.

Referring now to FIG. 4, there is illustrated one embodiment of passing a multilayer sandwich material 80 through a densification press and/or calender 100 resulting in a stiff fibrous boardstock material 90. In another embodiment, a single layer of the fibrous felted material 60 may be passed through a densification press and/or calender 100 resulting in a stiff fibrous boardstock material 90. In another embodiment of the present invention, a multilayer sandwich material 80 may be subjected to a double belt process to densify and bond the multilayer sandwich material 80. The double belt process allows the production to run as a continuous process and may allow the introduction of facings and functional layers to the stiff fibrous boardstock material 90. In yet another embodiment, a multilayer sandwich material 80 may be subjected to the use of ultrasonics to densify and bond the multilayer sandwich material

BO. In still another embodiment; a multilayer sandwich material BO may be subjected to the use of chemical solvents to bond the multilayer sandwich material 80. In yet another embodiment, a multilayer sandwich material 80 may be subjected to the use of hydroentangling to densify and bond the multilayer sandwich material BO. The stiff fibrous boardstock material 90 may then be trimmed to a desired length and/or width, such as 4 feet by 8 feet, as is a standard piece of plywood.

By way of example, a stiff fibrous boardstock material 90 may be produced by numerous processes. In one embodiment, a stiff fibrous boardstock material 90 is produced by carding staple fibers into a unified structure which is then needlepunched to integrate and entangle. Subsequent heat and pressure are applied to densify and create the stiff fibrous boardstock material 90. In another embodiment, staple fibers are wet laid or air laid into a unified structure which is then hydroentangled and densified to create a stiff fibrous boardstock material 90. In yet another embodiment, continuous filament fibers are formed into a web by melt-blowing, spunbonding, or threaded roll process. The web is then hydroentangled or needlepunched and densified to create a stiff fibrous boardstock material 90.

There are a multitude of products which may be constructed from nonwoven materials. The present invention describes a nonwoven product that is water resistant and impact resistant. The nonwoven product of the present invention begins in the form of a panel. A panel, as used herein, refers to a separate or distinct section or part of a surface. A panel may also refer to a flat or sculptured area that is part of a larger structure. In one embodiment of the present invention, a panel may define an interior and a perimeter profile of a protective armor product, a construction product, or combinations thereof. A panel is comprised of a stiff fibrous boardstock material.

The stiff fibrous boardstock material may be of substantially constant or varied thickness and comprises one or more layers of fibrous felted material of densified needlepunched construction, comprised of a plurality of entangled polymeric fibers. At least a portion of the entangled polymeric fibers are melt fused together such that a plurality of fiber to fiber fusion bonding points are distributed within the fibrous felted material. In one embodiment of the present invention, a stiff fibrous boardstock material may be of substantially constant thickness. In another embodiment, a stiff fibrous boardstock material may be of substantially varied thickness.

The density of the stiff fibrous boardstock material may range from uniform to varied. In one embodiment of the present invention, a stiff fibrous boardstock material may have a uniform density. In another embodiment of the present invention, a stiff fibrous boardstock material may be molded to be more dense in one area and less dense in another area. In yet another embodiment, a stiff fibrous boardstock material may be between 3/32 to 3/16 inches thick and have a density in the range of 24 ounces per yd² to 48 ounces per yd². In still another embodiment, a stiff fibrous boardstock material may be about ⅜ to 7/16 inches thick and have a density in the range of 48 ounces per yd² to 100 ounces per yd².

It is also possible to enhance the stiff fibrous boardstock material through a variety of techniques and processes. In one embodiment of the present invention, the stiff fibrous boardstock material may be enhanced by mechanically bonding, laminating, or changing staple or filament nonwoven layers to the surface of the stiff fibrous boardstock material. In another embodiment, the stiff fibrous boardstock material may be enhanced by hybridizing fibers, metal sheets, metal nonwoven scrims, films, flakes, powders or epoxy/acrylic coatings anywhere within the structure of the stiff fibrous boardstock material. In yet another embodiment, the stiff fibrous boardstock material may be enhanced by hybridizing fibers, metal sheets, metal nonwoven scrims, films, flakes, powders or epoxy/acrylic coatings anywhere externally to one or both sides of the stiff fibrous boardstock material. In still another embodiment, the stiff fibrous boardstock material may be enhanced by using polypropylene fibers to make the stiff fibrous boardstock material waterproof. In still another embodiment, the stiff fibrous boardstock material may be enhanced through the incorporation of a polyolefin or any woven or non-woven fabric having any denier and tensile strength. In still another embodiment, chemicals and/or additives may be used to engineer final properties of a stiff fibrous boardstock material.

In addition to the thermal plastic fibers made by the various processes described above, there are additional fibers that may be used to engineer desired properties into the stiff fibrous boardstock material. Manufacturers create these additional fibers through a variety of processes which include, but are not limited to, solution spinning, growing (as in natural plant fibers, man-made bacterial generated fibers, or animal fibers), mining of mineral fibers, or combinations thereof. Examples of fibers generated by the previously described processes include, but are not limited to, rayon, acetate, aramids, fiberglass, PBI, melamine, ceramics, metals, carbon, basalt, metalized carbon, wool, or combinations thereof. Manufacturers then include the additional fibers in various quantities to supplement the polymeric fibers used to create the fibrous boardstock material.

A fibrous felted material, as used herein, refers to a material of densified needlepunched construction, comprised of a plurality of entangled polymeric fibers. A plurality of entangled polymeric fibers, as used herein, refers to fibers which have been entangled by any known means. Methods of entanglement include, but are not limited to, carding, wet laying, air laying, melt blowing, hydroentangling, spunbonding, needling, or combinations thereof. The fibers that make up the entangled polymeric fibers may include a single type of fiber, or a blend of fibers. A plurality of entangled polymeric fibers may include, but are not limited to, polyolefin fibers, polyester fibers, nylon fibers, acrylic fibers, or combinations thereof. The denier of the fibers used may range between 1 and 20 denier.

In one embodiment of the present invention, the blend of fibers is comprised of polyester with about 30 percent to about 90 percent of the fibers being a standard PET polyester staple fiber. In another embodiment, the blend of fibers is comprised of polyester with about 50 percent to about 80 percent of the fibers being a standard PET staple fiber. In still another embodiment, the blend of fibers is comprised of polyester with about 70 percent of the fibers being a standard PET staple fiber. In still another embodiment, one standard PET polyester staple fiber is characterized by an average length of about 7.5 to 8 centimeters and a denier per filament rating of about dpf. However, other staple fibers may likewise be utilized if desired.

The blend of fibers may also include some percentage of a relatively low melting point constituent so as to permit the heat activated point bonding of fibers to one another at later processing stages. In one embodiment of the present invention, the blend of fibers may include bicomponent nylon/PET fibers, PET/coPET bicomponent binder fibers, or combinations thereof. In one embodiment of the present invention, the blend of fibers is comprised of about 10 percent to about 70 percent bicomponent polyester fibers comprising a core of a first polyester constituent characterized by a first melting point and a sheath of a second polyester constituent which is lower than the first melting point. The core/sheath bicomponent polyester fiber may have a denier per filament rating of about 2.5 to about 5.5 dpf.

In another embodiment, the blend of fibers is comprised of about 10 to 40 percent bicomponent polyester fibers comprising a core of a first polyester constituent characterized by a first melting point and a sheath of a second polyester constituent which is lower than the first melting point. In still another embodiment, the blend of fibers is comprised of about 30 percent bicomponent polyester fibers comprising a core of a first polyester constituent characterized by a first melting point and a sheath of a second polyester constituent which is lower than the first melting point.

In the previously described embodiments, with the application of sufficient heat, the sheath material melts and then bonds to surrounding fiber constituents resulting in the fibers becoming melt fused. In alternative embodiments, other forms of low melting point material such as discrete fibers of low melting point material may also be utilized. Likewise, at least some percentage of the fibers may be materials other than polyester. By way of example, it is contemplated that such materials may include nylon, polypropylene and the like.

Melt fused, as used herein, refers to the heating of one or more fibers within a plurality of entangle polymeric fibers to the fiber's melting point. As the fiber melts, the melted fiber then may bond to itself and any other fibers or materials that it may come into contact with. As the melted fiber bonds, fiber to fiber fusion bonding points result. Fiber to fiber fusion bonding points refers to the bonding points where both lower melting point fibers and higher melting point fibers bond with one another within a plurality of entangled polymeric fibers.

The nonwoven product may be used to construct armor used to protect an individual, a vehicle or a structure. The nonwoven product may also be used to construct any product traditionally constructed from plywood (including marine grade plywood), marine grade plastic, and the like. In one embodiment of the present invention, the nonwoven product is used to make a protective armor product. In another embodiment, the nonwoven product is used to make a construction product.

A protective armor product, as used herein, refers to a product which offers some form of protection to the user, wearer, structure, or vehicle. A protective armor product may be comprised of a variety of materials and may be presented in a variety of forms. In one embodiment of the present invention, a protective armor product may be comprised of panels, as described above. In another embodiment of the present invention, a protective armor product may be comprised of protective panels. In still another embodiment, a protective armor product may be comprised of molded structures. In still another embodiment, a protective armor product may be comprised of a combination of protective panels and molded structures.

A panel may define an interior and a perimeter profile of a protective armor product. In one embodiment of the present invention, a panel may refer to one section of body armor that an individual or animal may wear for protection. In another embodiment, a panel may refer to one part of a system of a protective armor product designed to protect structures such as buildings.

Protective panels refer to the above stiff fibrous boardstock material formed into panel shapes which may be mounted to a vehicle or structure. The protective panels may also be incorporated into personal body armor.

Molded structures refer to the above stiff fibrous boardstock material molded into a desired shape. The molded shapes may be mounted to a vehicle or structure. The molded shapes may also be incorporated into personal body armor.

The stiff fibrous boardstock material may be used as a protective panel or molded structure in protective apparel applications or as a panel to dissipate impact projectile force (back-face deformation panel) behind, sandwiched in-between or in front of ballistic vest. Stiff fibrous boardstock material may also be used to protect arms, legs and feet from impact of projectiles. In addition to protecting human life, these panels or molded structures can be used in military vehicles, aircraft, hard armor applications and architectural blast mitigation panels for buildings or any structure.

Energy dissipating, as used herein, refers to the absorbing, scattering, and spreading out of energy from a variety of sources including, but not limited to, an explosion, an impact, or combinations thereof.

A protective armor product may protect against a variety of threats including, but not limited to, an explosion, an explosive force, an impact force, or combinations thereof. In one embodiment of the present invention, a protective armor product is an energy dissipating protective armor product. In another embodiment, a protective armor product dissipates the blast energy from an explosion, dissipates the impact energy from a projectile, or combinations thereof. In another embodiment, a protective armor product absorbs the impulse and pressure generated by an explosion. In another embodiment of the present invention, a protective armor mitigates the potential damage caused by the shock waves generated by an explosion, an impact, or combinations thereof. In still another embodiment of the present invention, a protective armor product absorbs and dissipates the energy created by an explosion, an impact, or combinations thereof.

A protective armor product may be enhanced by and/or through any of the processes described above.

Construction product, as used herein, refers to a nonwoven product comprised of panels, as described above. The panels are comprised of the stiff fibrous boardstock material previously described. The stiff fibrous boardstock material may be molded or used in flat sheets as a lighter replacement for plywood applications. The stiff fibrous boardstock material may also be used as the deck flooring material in watercraft (pontoon boat-flooring), or just replacing marine plywood used in areas such as cushions or structural pieces covered in vinyl, leather or carpet within a boat, RV, mobile home, or anywhere excessive moisture can damage a wooden substrate. In one embodiment of the present invention, a construction product may be selected from the group comprising any article constructed from plywood (including marine grade plywood), marine grade plastic, or combinations thereof. In another embodiment, a construction product may be used to form components for items including, but not limited to, furniture, flooring, interior sheathing, exterior sheathing, boats, recreational vehicles, mobile homes, campers, boat docks, or combinations thereof.

As described above, a panel, as used herein, refers to a separate or distinct section or part of a surface. A panel may also refer to a flat or sculptured area that is part of a larger structure. A panel may define an interior and a perimeter profile of a construction product. In one embodiment of the present invention, a panel may refer to a section of a boat dock constructed for recreational or economic purposes. In yet another embodiment, a panel may refer to a structural or cosmetic part of a watercraft, which include, but are not limited to, a boat, a personal water craft, a raft, or combinations thereof. In yet another invention, a panel may refer to a structural or cosmetic part of a recreational vehicle, a camping vehicle, a camping structure, or combinations thereof. In still another embodiment, a panel may refer to a structural or cosmetic part of a piece of exercise equipment, such as a treadmill. In still another embodiment, a panel may refer to a structural or cosmetic part of a structure, such as a floor, wall, or ceiling.

A construction product may be enhanced by and/or through any of the processes described above.

This invention also describes a method of producing a nonwoven product which is comprised of a series of steps. The first step is to provide a stiff fibrous boardstock material comprised of one or more layers of fibrous felted material of densified needlepunched construction. The fibrous felted material is comprised of a plurality of entangled polymeric fibers and at least a portion of the entangled polymeric fibers are melt fused together such that a plurality of fiber to fiber fusion bonding points are distributed within the fibrous felted material. The stiff fibrous boardstock material may be of substantially constant or varied thickness. The second step is to form a panel from the stiff fibrous boardstock material which defines an interior and a perimeter profile of the nonwoven product. The third step is to form or construct the nonwoven product from the panels. The formed or constructed nonwoven product may include, but is not limited to, a protective armor product, a construction product, any article constructed from protective armor panels, molded armor structures, marine grade plywood, marine grade plastic, or combinations thereof.

In one embodiment of the method described above, the nonwoven product is resistant to damage caused by moisture. In another embodiment of the above method, the panels of the nonwoven product are used to form components for, or items which include, but are not limited to, furniture, flooring, interior sheathing, exterior sheathing, boats, recreational vehicles, mobile homes, campers, boat docks, panels for use with vehicles, panels for use with structures, panels being shaped to individually cover a wearer's body, arms, legs, head, feet, or combinations thereof. In yet another embodiment of the above method, the plurality of polymeric fibers may include, but are not limited to, a polyolefin, a bicomponent nylon/PET fiber, a PET/coPET bicomponent binder fiber, a PET fiber, a nylon fiber, an acrylic fiber, or combinations thereof. In still another embodiment of the above method, a nonwoven product dissipates the blast energy from an explosion, dissipates the impact energy from a projectile, or combinations thereof.

The present invention may be embodied in other forms without departing from the spirit and the essential attributes thereof, and, accordingly, reference should be made to the appended claims, rather than to the forgoing specification, as indicated in the scope of the invention.

We claim:

1. A protective armor product comprising:
a panel defining an interior and a perimeter profile of said protective armor product;
wherein said panel being comprised of a stiff fibrous boardstock material comprising one or more layers of fibrous felted material of densified needlepunched construction;
said fibrous felted material comprising a plurality of entangled polymeric fibers;
wherein at least a portion of said entangled polymeric fibers are melt fused together such that a plurality of fiber to fiber fusion bonding points are distributed within said fibrous felted material; and
wherein said stiff fibrous boardstock material being formed into said panels to make said protective armor product.

2. The protective armor product of claim 1, wherein said stiff fibrous board stock material being of substantially constant or varied thickness.

3. The protective armor product of claim 1, wherein said plurality of entangled polymeric fibers being selected from the group comprising: a polyolefin, a bicomponent nylon/PET fiber, a PET/coPET bicomponent binder fiber, a PET fiber, a nylon fiber, an acrylic fiber, or combinations thereof.

4. The invention as recited in claim 1, wherein about 10% to about 40% of said plurality of entangled polymeric fibers being bicomponent fibers comprising a core of a first polyester constituent characterized by a first melting point and a sheath of a second polyester constituent characterized by a second melting point which is lower than the first melting point.

5. The protective armor product of claim 1, wherein said product being selected from the group comprising: protective panels, molded structures, or combinations thereof.

6. The protective armor product of claim 1, wherein said protective armor product being an energy dissipating protective armor product.

7. The protective armor product of claim 6 wherein said energy dissipating protective armor product dissipates the blast energy from an explosion, dissipates the impact energy from a projectile, or combinations thereof.

8. The protective armor product of claim 1, wherein said protective armor product being enhanced through the process comprising: bonding, laminating, or changing staple or filament nonwoven layers to the surface, or hybridizing fibers, metal sheets, metal nonwoven scrims, films or epoxy/acrylic coatings anywhere within the structure or externally to one or both sides or by using polypropylene fibers to make the board material waterproof, or adding a polyolefin or any woven or non-woven fabric having any denier and tensile strength, or combinations thereof.

9. A construction product comprising:
a panel defining an interior and a perimeter profile of said construction product;
wherein said panel being comprised of a stiff fibrous boardstock material comprising one or more layers of fibrous felted material of densified needlepunched construction;
said fibrous felted material comprising a plurality of entangled polymeric fibers;
wherein at least a portion of said entangled polymeric fibers are melt fused together such that a plurality of fiber to fiber fusion bonding points are distributed within said fibrous felted material; and
wherein said stiff fibrous boardstock material being formed into the construction product.

10. The construction product of claim 9, wherein said stiff fibrous board stock material being of substantially constant or varied thickness.

11. The construction product of claim 9, wherein said plurality of entangled polymeric fibers being selected from the group comprising: a polyolefin, a bicomponent nylon/PET fiber, a PET/coPET bicomponent binder fiber, a PET fiber, a nylon fiber, an acrylic fiber, or combinations thereof.

12. The invention as recited in claim 9, wherein about 10% to about 40% of said plurality of entangled polymeric fibers being bicomponent fibers comprising a core of a first polyester constituent characterized by a first melting point and a sheath of a second polyester constituent characterized by a second melting point which is lower than the first melting point.

13. The construction product of claim 9, wherein the product being enhanced through the process comprising: bonding, laminating, or changing staple or filament nonwoven layers to the surface, or hybridizing fibers, metal sheets, metal nonwoven scrims, films or epoxy/acrylic coatings anywhere within the structure or externally to one or both sides or by using polypropylene fibers to make the board material waterproof, or adding a polyolefin or any woven or non-woven fabric having any denier and tensile strength, or combinations thereof.

14. The construction product of claim 9, wherein said nonwoven construction product is selected from the group comprising any article constructed from marine grade plywood, marine grade plastic, or combinations thereof.

15. The construction product of claim 9, wherein said nonwoven construction product being used to form components for items comprising: boats, recreational vehicles, mobile homes, campers, boat docks, or combinations thereof.

16. A method for the production of a nonwoven product comprising the steps of:
providing a stiff fibrous boardstock material, of substantially constant or varied thickness;
wherein said stiff fibrous board stock material comprises: one or more layers of fibrous felted material of densified needlepunched construction;
said fibrous felted material comprising a plurality of entangled polymeric fibers and wherein at least a portion of said entangled polymeric fibers are melt fused together such that a plurality of fiber to fiber fusion bonding points are distributed within said fibrous felted material;
forming a panel from said stiff fibrous boardstock material;
said panel defining an interior and a perimeter profile of said nonwoven product;
forming said nonwoven product from said panels where said nonwoven product is selected from the group comprising any article constructed from protective armor panels, molded armor structures, marine grade plywood, marine grade plastic, or combinations thereof.

17. The method of claim 16 wherein said nonwoven product being resistant to damage caused by moisture.

18. The method of claim 16 wherein said panels of said nonwoven product being used to form components for items comprising: boats, recreational vehicles, mobile homes, campers, boat docks, panels for use with vehicles, panels for use with structures, panels being shaped to individually cover a wearer's body, arms, legs, head, feet, or combinations thereof.

19. The method of claim 16 wherein said plurality of entangled polymeric fibers being selected from the group comprising: a polyolefin, a bicomponent nylon/PET fiber, a PET/coPET bicomponent binder fiber, a PET fiber, a nylon fiber, an acrylic fiber, or combinations thereof.

20. The method of claim 16 wherein said nonwoven product dissipates the blast energy from an explosion, dissipates the impact energy from a projectile, or combinations thereof.
